(19) United States
(12) Patent Application Publication
(10) Pub. No.: US 2024/0405816 A1
(43) Pub. Date: Dec. 5, 2024

(54) COMMUNICATION SYSTEM DESIGN METHOD BASED ON INTELLIGENT OMNI-SURFACE

(71) Applicant: CHINA INFORMATION CONSULTING & DESIGNING INSTITUTE CO., LTD, Nanjing (CN)

(72) Inventors: Jiakuo ZUO, Nanjing (CN); Chenming ZHU, Nanjing (CN); Qiang WANG, Nanjing (CN); Fengqiang PENG, Nanjing (CN)

(73) Assignee: CHINA INFORMATION CONSULTING & DESIGNING INSTITUTE CO., LTD, Nanjing (CN)

(21) Appl. No.: 18/578,068

(22) PCT Filed: Jul. 28, 2022
(86) PCT No.: PCT/CN2022/108546

§ 371 Date: Jan. 10, 2024

(30) Foreign Application Priority Data
Feb. 18, 2022 (CN) 202210151425.7

(51) Int. Cl. H04B 7/0456; H04B 7/04; H04B 7/0426

(52) U.S. Cl. CPC H04B 7/0465; H04B 7/04013; H04B 7/043

(57) ABSTRACT

It discloses a communication system design method based on an intelligent omni-surface, comprising step 1: constructing an optimization problem by minimizing a total power consumption of the communication system as an objective function, the communication system being a communication system based on an intelligent omni-surface; step 2: setting a constraint condition for the optimization problem constructed in the step 1, the constraint condition comprising a minimum rate constraint of a user, a phase shift constraint of the intelligent omni-surface and a length constraint of an allocated time slot; and step 3: solving the optimization problem after setting with the constraint condition to obtain solution for minimizing the total power consumption of the system. When lowest rate requirements of all users are met, the method reduces the total power consumption of the system and realizes omnidirectional coverage of a communication area, and has a good application value.

### TECHNICAL FIELD

The present invention relates to a communication system design method, and particularly, to a communication system design method based on an intelligent omni-surface.

### BACKGROUND

In the future, 6G wireless communication network will realize “intelligent connection”, “deep connection”, “holographic connection” and “ubiquitous connection”, and the realization of this vision requires that the communication network can meet “a connection capacity of hundreds of billions of devices”, “an access rate like an optical fiber” and “a zero delay experience”, which poses new and great challenges to the next generation communication network. An intelligent omni-surface is a new wireless communication technology and a passive device, which has the characteristics of low power consumption, full-band response and easy deployment, and is considered as one of the most promising technologies to solve difficulties faced by the wireless communication network in the future.

The existing research on intelligent reflecting surface technology only considers the situation that both a user and a base station are distributed on the same side of the intelligent omni-surface, that is, the intelligent reflecting surface can only reflect a signal from base station or the user, but for the user distributed on the back of the intelligent reflecting surface, a communication coverage cannot be achieved. Therefore, the traditional intelligent reflecting surface can only achieve the coverage of a semi-communication area, but cannot achieve the 360° omnidirectional coverage of the communication area. Based on this situation, the present invention proposes a communication system design method based on an intelligent omni-surface, and optimizes the system with the goal of minimizing a total power consumption of the system.

### SUMMARY

Object of the present invention: the technical problem to be solved by the present invention is to provide a communication system design method based on an intelligent omni-surface, aiming at the shortcomings in the prior art.

In order to solve the technical problem, the present invention discloses a communication system design method based on an intelligent omni-surface, comprising a computer readable medium operable on a computer with memory for communication system design method, and comprising program instructions for executing the following steps of:
step 1: constructing an optimization problem by minimizing a total power consumption of the communication system as an objective function, the communication system being a communication system based on an intelligent omni-surface;
step 2: setting a constraint condition for the optimization problem constructed in the step 1, the constraint condition comprising: a minimum rate constraint of a user, a phase shift constraint of the intelligent omni-surface and a length constraint of an allocated time slot; and
step 3: solving the optimization problem after setting with the constraint condition to obtain an optimization solution for minimizing the total power consumption of the system.

The intelligent omni-surface in the step 1 of the present invention is applied to an uplink communication, and a user communicates with a base station under the assistance of the intelligent omni-surface.

Each element of the intelligent omni-surface in the step 1 has two working modes, which are a reflection mode and a transmission mode; wherein, in the reflection mode, each element is capable of reflecting an incident signal; in the transmission mode, the incident signal is capable of being transmitted through the element of the intelligent omni-surface; the intelligent omni-surface works by using a time slot switching protocol, and two time slots are provided, which are a time slot 1 and a time slot 2; in the time slot 1 respectively, all elements of the intelligent omni-surface work in the reflection mode, and the covered communication area is a reflection area; and in the time slot 2, all elements of the intelligent omni-surface work in the transmission mode, and the covered communication area is a transmission area.

The optimization problem in the step 1 is as follows:

$${min}_{{p}_{k} , {t}_{k} > 0 , {θ}_{m}^{k}} ( {p}_{1} + {p}_{2} )$$

wherein, (p₁+p₂) is the total power consumption of the system, pₖ is a transmit power of a user k, tₖ is a length of a time slot k, and θₘ^{k} is a phase shift of an m^{th} element of the intelligent omni-surface in the time slot k.

The constraint condition in the step 2 of the present invention comprises:

$$a constraint condition 1 : {R}_{k} \geq {R}_{k}^{min} , k ∈ \{ 1 , 2 \} a constraint condition 2 : {θ}_{m}^{k} ∈ [ 0 , 2 π ) , k ∈ \{ 1 , 2 \} , m ∈ \{ 1 , 2 , … , M \} \\ a constraint condition 3 : {t}_{1} + {t}_{2} = 1 , 0 < {t}_{1} < 1 , 0 < {t}_{2} < 1$$

wherein, Rₖ^{min} is a minimum rate threshold value of the user k, π is a ratio of circumference to diameter, M is a total number of the elements contained in the intelligent omni-surface,

$${R}_{k} = {t}_{k} {log}_{2} ( 1 + \frac{{p}_{k} {\vert {h}^{H} {Θ}_{k} {g}_{k} \vert}^{2}}{{σ}^{2}} )$$

is an achievable data rate of the user k, h∈C^{M×1} is a channel vector between the intelligent omni-surface and the base station, gₖ∈C^{M×1} is a channel vector between the user k and the intelligent omni-surface, Θ₁=diag {e^{jθ}^{₁}¹e^{jθ}^{₂}¹ . . . e^{jθ}^{_{M}}¹} and Θ₂=diag {e^{jθ}^{₁}²e^{jθ}^{₂}² . . . e^{jθ}^{_{M}}²} are a reflected beamforming matrix and a transmitted beamforming matrix respectively, σ² is a variance of an additive white Gaussian noise, C^{M×1} represents a complex column vector of M dimension, |⋅|² represents a square of a complex modulus, (⋅)^{H} represents a conjugate transpose of a vector, diag{⋅} represents to converting the vector to a diagonal matrix, and e^{j⋅} represents an exponential form of complex number; and the constraint condition 1 is the minimum rate constraint of the user; the constraint condition 2 is the phase shift constraint of the intelligent omni-surface; and the constraint condition 3 is the length constraint of the total slot time of the time slot 1 and the time slot 2 after normalization.

The method for solving the optimization problem after setting with the constraint condition in the step 3 comprises:
step 3-1: calculating the phase shift of the intelligent omni-surface; and
step 3-2: calculating the transmit power of the user and the time slot length.

The method for the calculating the phase shift of the intelligent omni-surface in the step 3-1 in the present invention comprises:
the method for calculating the phase shift θₘ^{k} of the m^{th} element of the intelligent omni-surface in the time slot k is as follows:

$${θ}_{m}^{k} = \{ \begin{matrix}{θ}_{m}^{h} - {θ}_{m}^{{g}_{k}} , & if {θ}_{m}^{h} - {θ}_{m}^{{g}_{k}} \geq 0 \\ 2 π + ( {θ}_{m}^{h} - {θ}_{m}^{{g}_{k}} ) , & if {θ}_{m}^{h} - {θ}_{m}^{{g}_{k}} < 0\end{matrix}$$

wherein, θₘ^{h} and θₘ^{g}^{ₖ} are phases of m^{th} elements of vectors h and gₖ respectively, k∈{1,2} and m∈{1,2, . . . , M}.

The method for the calculating the transmit power of the user and the time slot length in the step 3-2 comprises:
step 3-2-1: initializing a searching step-size Δ^{t} and a search index τ=0;
step 3-2-2, updating an iteration index τ=τ+1 and the time slot length t₂=τ× Δt;
step 3-2-3, calculating the transmit power for the user;
step 3-2-4: calculating the total power consumption of the system during the τ^{th} iteration:

$${P}_{sum}^{τ} = {p}_{1} + {p}_{2} ;$$

step 3-2-5, when t₂<1, executing the step 3-2-2; otherwise, executing step 3-2-6;
step 3-2-6, according to all the obtained total power consumption of the system {Pₛᵤₘ^{τ}}, calculating the optimal iteration index Top corresponding to the minimum total power consumption of the system, which is

$${τ}_{op} = {min}_{τ} \{ {P}_{sum}^{τ} \} ;$$

and
step 3-2-7, outputting the optimal time slot length t₂^{op}=τₒₚ×Δt; and outputting the optimal transmit power.

The method for calculating the transmit power of the user in the step 3-2-3 of the present invention is as follows:

$${p}_{1} = \frac{{σ}^{2}}{{\vert {h}^{H} {Θ}_{1} {g}_{1} \vert}^{2}} ( {2}^{\frac{{R}_{1}^{min}}{1 - {t}_{2}}} - 1 ) \\ {p}_{2} = \frac{{σ}^{2}}{{\vert {h}^{H} {Θ}_{2} {g}_{2} \vert}^{2}} ( {2}^{\frac{{R}_{2}^{min}}{{t}_{2}}} - 1 ) .$$

The optimal transmit power in the step 3-2-7 is:

$${p}_{1}^{op} = \frac{{σ}^{2}}{{\vert {h}^{H} {Θ}_{1} {g}_{1} \vert}^{2}} ( {2}^{\frac{{R}_{1}^{min}}{{t}_{1}^{op}}} - 1 ) \\ {p}_{2}^{op} = \frac{{σ}^{2}}{{\vert {h}^{H} {Θ}_{2} {g}_{2} \vert}^{2}} ( {2}^{\frac{{R}_{2}^{min}}{{t}_{2}^{op}}} - 1 )$$

wherein, p₁^{op} and p₂^{op} represent optimal transmit powers of a user 1 and a user 2, respectively, while t₁^{op} and t₂^{op} represent optimal lengths of the time slot 1 and the time slot 2 respectively.

### Beneficial Effects:

the present invention provides the 360° omnidirectional communication coverage by using the intelligent omni-surface, so that the users distributed on both sides of the intelligent omni-surface can communicate with the base station with the assistance of the intelligent omni-surface, and the total power consumption of the system is reduced and the communication coverage area is improved by optimizing the phase shift of the intelligent omni-surface, the transmit power of the user and the allocated time slot length.

### BRIEF DESCRIPTION OF THE DRAWINGS

The present invention is further described in detail with reference to the accompanying drawings and the detailed descriptions, and the advantages of the above and/or other aspects of the present invention will become clearer.

FIG. 1 is a schematic diagram of a system model of the present invention.

FIG. 2 is a schematic change diagram of a total power consumption of the system according to the present invention with a number of intelligent omni-surface elements.

FIG. 3 is a schematic change diagram of the total power consumption of the system according to the present invention with a minimum rate threshold value.

### DETAILED DESCRIPTION

In order to overcome the shortcomings in the prior art, the present invention provides a communication system design method based on an intelligent omni-surface. The present invention provides the 360° omnidirectional communication coverage by using the intelligent omni-surface, so that the users distributed on both sides of the intelligent omni-surface can communicate with the base station with the assistance of the intelligent omni-surface, and the total power consumption of the system is reduced by optimizing the phase shift of the intelligent omni-surface, the transmit power of the user and the allocated time slot length.

The communication system design method based on the intelligent omni-surface is concretely realized as follows:

the intelligent omni-surface is applied to an uplink communication, and a user communicates with a base station under the assistance of the intelligent omni-surface.

Each element of the intelligent omni-surface has two working modes, which are a reflection mode and a transmission mode; wherein, in the reflection mode, each element is capable of reflecting an incident signal; in the transmission mode, the incident signal is capable of being transmitted through the element of the intelligent omni-surface; the intelligent omni-surface works by using a time slot switching protocol, and two time slots are provided, which are a time slot 1 and a time slot 2 respectively. In the time slot 1, all elements of the intelligent omni-surface work in the reflection mode, and the covered communication area is a reflection area. In the time slot 2, all elements of the intelligent omni-surface work in the transmission mode, and the covered communication area is a transmission area.

Furthermore, the optimizing the communication system based on the intelligent omni-surface comprises the following steps of:
step (1-1): constructing an optimization problem by minimizing a total power consumption of the system as an objective function, and using a minimum rate constraint of a user, a phase shift constraint of the intelligent omni-surface and a length constraint of an allocated time slot as constraint conditions.
step (1-2): solving the constructed optimization problem minimizing the total power consumption of the system to obtain an optimization solution for minimizing the total power consumption of the system.

The optimization problem constructed in the step (1-1) is as follows:

$${min}_{{p}_{k} , {t}_{k} > 0 , {θ}_{m}^{k}} ( {p}_{1} + {p}_{2} ) a constraint condition 1 : {R}_{k} \geq {R}_{k}^{min} , k ∈ \{ 1 , 2 \} a constraint condition 2 : {θ}_{m}^{k} ∈ [ 0 , 2 π ) , k ∈ \{ 1 , 2 \} , m ∈ \{ 1 , 2 , … , M \} \\ a constraint condition 3 : {t}_{1} + {t}_{2} = 1 , 0 < {t}_{1} < 1 , 0 < {t}_{2} < 1$$

wherein, (p₁+p₂) is the total power consumption of the system, pₖ is a transmit power of a user k, tₖ is a length of a time slot k, θₘ^{k} is a phase shift of an m^{th} element of the intelligent omni-surface in the time slot k, Rₖ^{min} is a minimum rate threshold value of the user k, π is a ratio of circumference to diameter, M is a total number of the elements contained in the intelligent omni-surface,

$${R}_{k} = {t}_{k} {log}_{2} ( 1 + \frac{{p}_{k} {\vert {h}^{H} {Θ}_{k} {g}_{k} \vert}^{2}}{{σ}^{2}} )$$

is an achievable data rate of the user k, h∈C^{M×1} is a channel vector between the intelligent omni-surface and the base station, gₖ∈C^{M×1} is a channel vector between the user k and the intelligent omni-surface, Θ₁=diag {e^{jθ}^{₁}¹e^{jθ}^{₂}¹ . . . e^{jθ}^{_{M}}¹} and Θ₂=diag {e^{jθ}^{₁}²e^{jθ}^{₂}² . . . e^{jθ}^{_{M}}²} are a reflected beamforming matrix and a transmitted beamforming matrix respectively, σ² is a variance of an additive white Gaussian noise, C^{M×1} represents a complex column vector of M dimension, |⋅|² represents a square of a complex modulus, (⋅)^{H} represents a conjugate transpose of a vector, diag {⋅} represents to converting the vector to a diagonal matrix, and e^{j⋅} represents an exponential form of complex number. The constraint condition 1 is the minimum rate constraint of the user; the constraint condition 2 is the phase shift constraint of the intelligent omni-surface; and the constraint condition 3 is the length constraint of the total slot time of the time slot 1 and the time slot 2 after normalization.

In the step (1-2), the optimization solution for minimizing the total power consumption of the system comprises the following steps of:
step (1-2-1): calculating the phase shift of the intelligent omni-surface; and
step (1-2-2): calculating the transmit power of the user and the time slot length.

In the step (1-2-1), the phase shift θₘ^{k} of the m^{th} element of the intelligent omni-surface in the time slot k is obtained by the following calculation:

$${θ}_{m}^{k} = \{ \begin{matrix}{θ}_{m}^{h} - {θ}_{m}^{{g}_{k}} , & if {θ}_{m}^{h} - {θ}_{m}^{{g}_{k}} \geq 0 \\ 2 π + ( {θ}_{m}^{h} - {θ}_{m}^{{g}_{k}} ) , & if {θ}_{m}^{h} - {θ}_{m}^{{g}_{k}} < 0\end{matrix}$$

wherein, θₘ^{h} and θₘ^{g}^{ₖ} are phases of m^{th} elements of vectors h and gₖ respectively, k∈{1,2} and me {1,2, . . . , M}.

In the step (1-2-2), the transmit power of the user and the time slot length are obtained by the following process calculation:
step (1): initializing a searching step-size Δt and a search index τ=0;
step (2): updating an iteration index τ=τ+1 and the time slot length t₂=τ×Δt;
step (3): calculating the transmit power for the user:

$${p}_{1} = \frac{{σ}^{2}}{{\vert {h}^{H} {Θ}_{1} {g}_{1} \vert}^{2}} ( {2}^{\frac{{R}_{1}^{min}}{1 - {t}_{2}}} - 1 ) and \\ {p}_{2} = \frac{{σ}^{2}}{{\vert {h}^{H} {Θ}_{2} {g}_{2} \vert}^{2}} ( {2}^{\frac{{R}_{2}^{min}}{{t}_{2}}} - 1 ) ;$$

step (4): calculating the total power consumption of the system during the τ^{th} th iteration:

$${P}_{sum}^{τ} = {p}_{1} + {p}_{2} ;$$

step (5): when 42<1, executing the step 3-2-2; otherwise, executing step 3-2-6;
step (6): according to all the obtained total power consumption of the system {pₛᵤₘ^{τ}}, sum calculating the optimal iteration index τₒₚ corresponding to the minimum total power consumption of the system, which is

$${τ}_{opp} = {min}_{τ} \{ {P}_{sum}^{τ} \} ;$$

and
step (7): outputting the optimal time slot length t₂^{op}=τₒₚ×Δt; and outputting the optimal transmit power

$${p}_{1}^{op} = \frac{{σ}^{2}}{{\vert {h}^{H} {Θ}_{1} {g}_{1} \vert}^{2}} ( {2}^{\frac{{R}_{1}^{min}}{{t}_{1}^{op}}} - 1 ) and \\ {p}_{2}^{op} = \frac{{σ}^{2}}{{\vert {h}^{H} {Θ}_{2} {g}_{2} \vert}^{2}} ( {2}^{\frac{{R}_{2}^{min}}{{t}_{2}^{op}}} - 1 ) .$$

### Embodiment

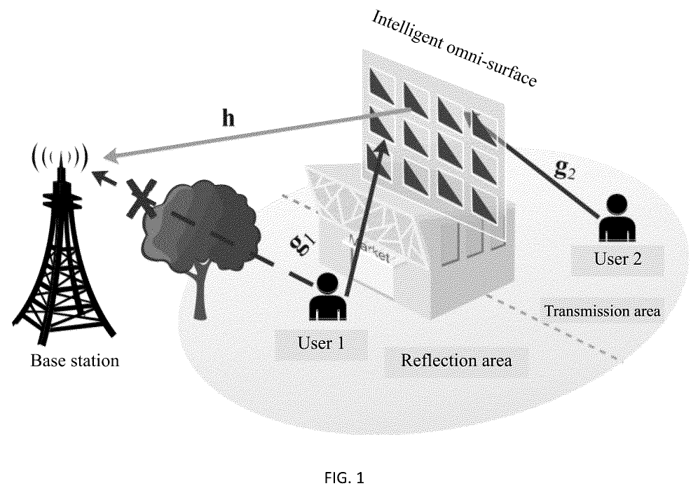

FIG. 1 shows a system model of the present invention. A communication system based on an intelligent omni-surface comprises a base station, an omni-directional intelligent hypersurface and two users. A user 1 and a user 2 are located on both sides of the intelligent omni-surface respectively. It is assumed that both the base station and the user are equipped with an antenna, and the intelligent omni-surface consists of m elements. Considering the uplink communication, direct link communication between the user and the base stations is impossible due to channel blockage or serious fading, and the communication with the base stations must be assisted by the intelligent omni-surface. Further, it is assumed that the base station can accurately obtain all channel state information between the base station and the intelligent omni-surface and between the user and the intelligent omni-surface.

Each element of the intelligent omni-surface in the step 1 has two working modes, which are a reflection mode and a transmission mode; wherein, in the reflection mode, each element is capable of reflecting an incident signal; and in the transmission mode, the incident signal is capable of being transmitted through the element of the intelligent omni-surface. The intelligent omni-surface works by using a time slot switching protocol, and two time slots are provided, which are a time slot 1 and a time slot 2 respectively. In the time slot 1, all elements of the intelligent omni-surface work in the reflection mode, and the covered communication area is a reflection area. In the time slot 2, all elements of the intelligent omni-surface work in the transmission mode, and the covered communication area is a transmission area, as shown in FIG. 1. θₘ¹ and θₘ² are set as the phase shifts of the m^{th} element of the intelligent omni-surface in the time slot 1 and the time slot 2 respectively. So, the reflected beamforming matrix and the transmitted beamforming matrix are represented as Θ₁=diag{e^{jθ}^{₁}¹e^{jθ}^{₂}¹ . . . e^{jθ}^{_{M}}¹} and Θ₂=diag {e^{jθ}^{₁}²e^{jθ}^{₂}² . . . e^{jθ}^{_{M}}²} respectively, wherein diag{⋅} represents to converting the vector to a diagonal matrix, and e^{j⋅} represents an exponential form of complex number.

h∈C^{M×1} is set to represent a channel between the intelligent omni-surface and the base station, gₖ∈C^{m×1} represents a channel between the user k and the intelligent omni-surface, and C^{M×1} represents a complex column vector of M dimension. In the time slot k, a signal received by the base station is as follows:

$${y}_{k} = {h}^{H} {Θ}_{k} {g}_{k} {x}_{k} + {z}_{k} , k ∈ \{ 1 , 2 \} \qquad Formula ( 1 )$$

wherein, xₖ represents a signal sent by the user k, zₖ is an additive white Gaussian noise of the base station in the time slot k, with a mean value of 0, and a variance is σ².

According to the formula (1), a rate Rₖ of the user k is:

$${R}_{k} = {t}_{k} {log}_{2} ( 1 + \frac{{p}_{k} \vert {h}^{H} {Θ}_{k} {g}_{k} {\vert}^{2}}{{σ}^{2}} ) \qquad Formula ( 2 )$$

wherein, pₖ is a transmit power of a user k, tₖ is a length of a time slot k, and |⋅|² represents a square of a complex modulus.

With the consideration of the minimum rate constraint of the user, the phase shift constraint of the intelligent omni-surface and the length constraint of the allocated time slot, the optimization problem for minimizing the total power consumption of the system is as follows:

$${min}_{{p}_{k} , {t}_{k} > 0 , {θ}_{m}^{k}} ( {p}_{1} + {p}_{2} ) \qquad Formula ( 3. a )$$

$$a constraint condition : {R}_{k} \geq {R}_{k}^{min} , k ∈ \{ 1 , 2 \} \qquad Formula ( 3. b )$$

$$a constraint condition : {θ}_{m}^{k} ∈ [ 0 , 2 π ) , k ∈ \{ 1 , 2 \} , m ∈ \{ 1 , 2 , … , M \} \qquad Formula ( 3. c )$$

$$a constraint condition : {t}_{1} + {t}_{2} = 1 , 0 < {t}_{1} < 1 , 0 < {t}_{2} < 1 \qquad Formula ( 3. d )$$

wherein, (p₁+p₂) is the total power consumption of the system, Rₖ^{min} is a minimum rate threshold value of the user k, and π is a ratio of circumference to diameter. The constraint condition (3.b) is the minimum rate constraint of the user; the constraint condition (3.c) is the phase shift constraint of the intelligent omni-surface; and the constraint condition (3.d) is the length constraint of the total slot time of the time slot 1 and the time slot 2 after normalization

The optimization problem is solved to obtain the optimization solution for minimizing the total power consumption of the system. The concrete process of the solution comprises the following steps of:
step (1-1): calculating the phase shift of the intelligent omni-surface; and
step (1-2): calculating the transmit power of the user and the time slot length.

The specific implementation process of the above steps is described in detail below.

### (I) Calculating the Phase Shift of the Intelligent Omni-Surface

The phase shift of the intelligent omni-surface IS obtained by maximizing an equivalent combined channel gain of a user, which is:

$${max}_{{θ}_{m}^{k}} {\vert {h}^{H} {Θ}_{k} {g}_{k} \vert}^{2} \qquad Formula ( 4. a )$$

$$constraint condition : {θ}_{m}^{k} ∈ [ 0 , 2 π ) , k ∈ \{ 1 , 2 \} , m ∈ \{ 1 , 2 , … , M \} \\ {h}_{m} = \vert {h}_{m} \vert {e}^{{j}^{} {θ}_{m}^{h}} and {g}_{k , m} = \vert {g}_{k , m} \vert {e}^{{j}^{} {θ}_{m}^{g} k} \qquad Formula ( 4. b )$$

are set to represent m^{th} elements of vectors h and gₖ respectively, |hₘ| and θₘ^{h} are an amplitude and a phase of hₘ respectively, while |g_{k,m}| and θₘ^{g}^{ₖ} are an amplitude and a phase of g_{k,m} respectively. The objective function |h^{H}Θₖgₖ|² in the formula (4) has the following relationship:

$$\vert {h}^{H} {Θ}_{k} {g}_{k} \vert = \vert {\sum }_{m = 1}^{M} \vert {h}_{m} \vert \vert {g}_{k , m} \vert {e}^{j {θ}_{m}^{k} - {θ}_{m}^{h} + {θ}_{m}^{g k}} \vert \leq {\sum }_{m = 1}^{M} \vert {h}_{m} \vert \vert {g}_{k , m} \vert \qquad Formula ( 5 )$$

When and only when θₘ^{k}−θₘ^{k}+θₘ^{g}^{ₖ}=0 or θₙ^{k}−θₘ^{h}+θₘ^{g}^{ₖ}=2π, the equality in (5) will hold.

Therefore, the phase shift of the m^{th} element of the intelligent omni-surface is obtained by the following formula:

$${θ}_{m}^{k} = \{ \begin{matrix}{θ}_{m}^{h} - {θ}_{m}^{{g}_{k}} , & if {θ}_{m}^{h} - {θ}_{m}^{{g}_{k}} \geq 0 \\ 2 π + ( {θ}_{m}^{h} - {θ}_{m}^{{g}_{k}} ) , & if {θ}_{m}^{h} - {θ}_{m}^{{g}_{k}} < 0\end{matrix} \qquad Formula ( 6 )$$

### (II) Calculating the Transmit Power of the User and the Time Slot Length

For the given phase shift {θₘ^{k}} of the intelligent omni-surface phase shift, the optimization problem of the transmit power of the user and the time slot length in the optimization problem (3) is represented as:

$${min}_{{p}_{k} , {t}_{k} > 0} ( {p}_{1} + {p}_{2} ) \qquad Formula ( 7. a )$$

$$constraint condition : {R}_{k} \geq {R}_{k}^{min} , k ∈ \{ 1 , 2 \} \qquad Formula ( 7. b )$$

$$constraint condition : {t}_{1} + {t}_{2} = 1 , 0 < {t}_{1} < 1 , 0 < {t}_{2} < 1 \qquad Formula ( 7. c )$$

The equivalent conversion is performed on the constraint condition formula (7.b) to

$$obtain : {p}_{k} \geq \frac{{σ}^{2}}{{\vert {h}^{H} {Θ}_{k} {g}_{k} \vert}^{2}} ( {2}^{\frac{{R}_{k}^{min}}{{t}_{k}}} - 1 ) .$$

The objective function of the optimization problem (7) is to minimize the sum of the transmit powers of the user 1 and the user 2. Therefore, when the transmit powers p1 and p2 are simultaneously minimized, which is:

$${p}_{{k}^{=}} \frac{{σ}^{2}}{{\vert {h}^{H} {Θ}_{k} {g}_{k} \vert}^{2}} ( {2}^{\frac{{R}_{k}^{min}}{{t}_{k}}} - 1 ) \qquad Formula ( 8 )$$

the total power consumption (p₁+p₂) of the system reaches a minimum value, wherein |⋅| is a modulus of a complex number.

It can be seen from the formula (8), the transmit power pₖ is a function of the time slot length tₖ. As t₁=1−t₂, and 0<t₂<1, the total power consumption is represented as a one-dimensional function of the time slot length t₂. Therefore, the optimal time slot length is obtained by a one-dimensional search algorithm. The specific process of using the one-dimensional search algorithm to solve the transmit power of the user and the time slot length is as follows:
step (1): initializing a searching step-size Δt and a search index τ=0;
step (2): updating an iteration index τ=τ+1 and the time slot length t₂=τ×Δ;
step (3): calculating the transmit power for the user:

$${p}_{1} = \frac{{σ}^{2}}{{\vert {h}^{H} {Θ}_{1} {g}_{1} \vert}^{2}} ( {2}^{\frac{{R}_{1}^{min}}{1 - {t}_{2}}} - 1 ) and$$

$${p}_{2} = \frac{{σ}^{2}}{{\vert {h}^{H} {Θ}_{2} {g}_{2} \vert}^{2}} ( {2}^{\frac{{R}_{2}^{min}}{{t}_{2}}} - 1 ) ;$$

step (4): calculating the total power consumption of the system during the τ^{th} iteration:

$${P}_{sum}^{τ} = {p}_{1} + {p}_{2} ;$$

step (5): when t₂<1, executing the step 3-2-2; otherwise, executing step 3-2-6;
step (6): according to the obtained {Pₛᵤₘ^{τ}}, calculating the optimal iteration index τₒₚ corresponding to the minimum Pₛᵤₘ^{τ}, which is

$${τ}_{op} = {min}_{τ} \{ {P}_{sum}^{τ} \} ;$$

and
step (7): outputting the optimal time slot length t₂^{op}=τₒₚ×Δt; and outputting the optimal transmit power

$${p}_{1}^{op} = \frac{{σ}^{2}}{{\vert {h}^{H} {Θ}_{1} {g}_{1} \vert}^{2}} ( {2}^{\frac{{R}_{1}^{min}}{{t}_{1}^{op}}} - 1 ) and$$

$${p}_{2}^{op} = \frac{{σ}^{2}}{{\vert {h}^{H} {Θ}_{2} {g}_{2} \vert}^{2}} ( {2}^{\frac{{R}_{2}^{min}}{{t}_{2}^{op}}} - 1 ) .$$

Then, the present invention is simulated and a performance thereof is analyzed. In the simulation, it is assumed that coordinates of the base station and the intelligent omni-surface are (0 m, 20 m) and (50 m, 20 m) respectively, and the coordinates of the user 1 and the user 2 are (x1, 0 m) and (x2, 0 m) respectively, wherein x1 is randomly distributed between (40 m, 50 m) and x2 is randomly distributed between (50 m, 60 m). All the channels involved are modeled by a Rice channel, and a path loss exponent is assumed to be 2.2. Without the loss of generality, it is assumed that the minimum rate threshold value of the user is R₁^{min}=R₂^{min}=Rₘᵢₙ (bit/s/Hz).

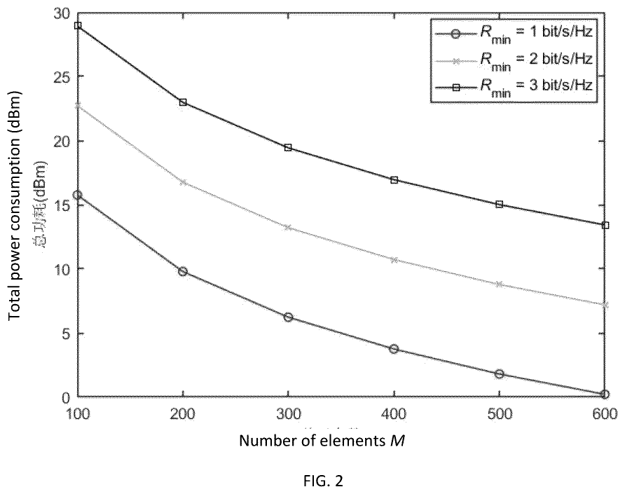

As shown in FIG. 2, under different minimum rate threshold values Rₘᵢₙ, it is a relationship diagram between the total power consumption of the system of the present invention and the number of the intelligent omni-surface elements M. It can be seen from the figure, when the minimum rate threshold value Rₘᵢₙ is fixed, the total power consumption of the system decreases with the increase of the number of the intelligent omni-surface elements M. When the number of the intelligent omni-surface elements M is fixed, the total power consumption of the system increases with the increase of the minimum rate threshold value Rₘᵢₙ.

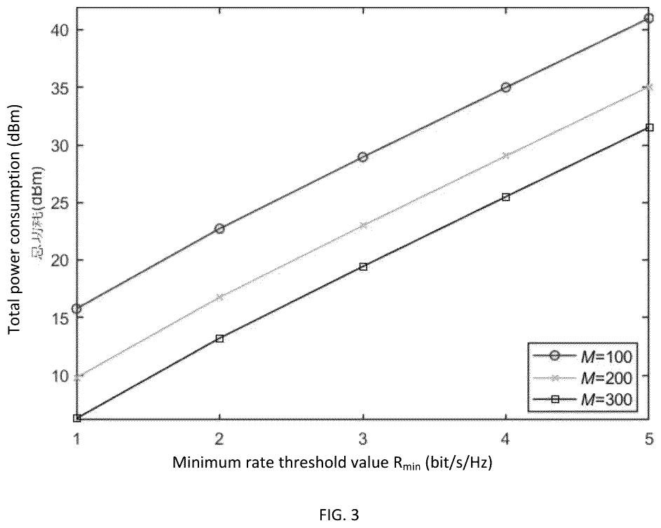

As shown in FIG. 3, it is the relationship diagram between the total power consumption of the system of the present invention and the minimum rate threshold value Rₘᵢₙ is shown under different numbers M of the intelligent omni-surface elements. It can be seen from the figure, when the number of the intelligent omni-surface elements M is fixed, the total power consumption of the system increases with the increase of the minimum rate threshold value Rₘᵢₙ. When the minimum rate threshold value Rₘᵢₙ is fixed, the total power consumption of the system decreases with the increase of the number of the intelligent omni-surface elements M.

The intelligent omni-surface comprises a computer readable medium operable on a computer with memory for the communication system method, and program instructions for executing the communication system method.

The present invention provides the idea and the method of the communication system method based the intelligent omni-surface. There are many methods and ways to realize the technical solutions. The above only describes the specific embellishments of the present invention. It should be pointed out that those of ordinary skills in the art can make some improvements and embellishments without departing from the principle of the present invention, and these improvements and embellishments should also be regarded as falling with the scope of protection of the present invention. All the unspecified components in the embodiments can be realized by the prior art.

The invention claimed is:

1. A communication system design method based on an intelligent omni-surface, comprising a computer readable medium operable on a computer with memory for the communication system design method, and comprising program instructions for executing the following steps of:
step 1: constructing an optimization problem by minimizing a total power consumption of the communication system as an objective function, the communication system being a communication system based on an intelligent omni-surface;
step 2: setting a constraint condition for the optimization problem constructed in the step 1, the constraint condition comprising: a minimum rate constraint of a user, a phase shift constraint of the intelligent omni-surface and a length constraint of an allocated time slot; and
step 3: solving the optimization problem after setting with the constraint condition to obtain solution for minimizing the total power consumption of the system and improving communication coverage area.

2. The communication system design method based on the intelligent omni-surface according to claim 1, wherein the intelligent omni-surface in the step 1 is applied to an uplink communication, and a user communicates with a base station under the assistance of the intelligent omni-surface.

3. The communication system design method based on the intelligent omni-surface according to claim 2, wherein each element of the intelligent omni-surface in the step 1 has two working modes, which are a reflection mode and a transmission mode; wherein, in the reflection mode, each element is capable of reflecting an incident signal; in the transmission mode, the incident signal is capable of being transmitted through the element of the intelligent omni-surface; the intelligent omni-surface works by using a time slot switching protocol, and two time slots are provided, which are a time slot 1 and a time slot 2 respectively; in the time slot 1, all elements of the intelligent omni-surface work in the reflection mode, and the covered communication area is a reflection area; and in the time slot 2, all elements of the intelligent omni-surface work in the transmission mode, and the covered communication area is a transmission area.

4. The communication system design method based on the intelligent omni-surface according to claim 3, wherein the optimization problem in the step 1 is as follows:
$${min}_{{p}_{k} , {t}_{k} > 0 , {θ}_{m}^{k}} ( {p}_{1} + {p}_{2} )$$
wherein, (p₁+p₂) is the total power consumption of the system, pₖ is a transmit power of a user k, tₖ this a length of a time slot k, and θₘ^{k}, is a phase shift of an m^{th} element of the intelligent omni-surface in the time slot k.

5. The communication system design method based on the intelligent omni-surface according to claim 4, wherein the constraint condition in the step 2 comprises:
$$a constraint condition 1 : {R}_{k} \geq {R}_{k}^{min} , k ∈ \{ 1 , 2 \}$$
$$a constraint condition 2 : {θ}_{m}^{k} ∈ [ 0 , 2 π ) , k ∈ \{ 1 , 2 \} , m ∈ \{ 1 , 2 , ⋯ , M \}$$
$$a constraint condition 3 : {t}_{1} + {t}_{2} = 1 , 0 < {t}_{1} < 1 , 0 < {t}_{2} < 1$$
wherein, Rₖ^{min} is a minimum rate threshold value of the user k, π is a ratio of circumference to diameter, M is a total number of the elements contained in the intelligent omni-surface,
$${R}_{k} = {t}_{k} {log}_{2} ( 1 + \frac{{p}_{k} {\vert {h}^{H} {Θ}_{k} {g}_{k} \vert}^{2}}{{σ}^{2}} )$$
is an achievable data rate of the user k, h∈C^{M×1} is a channel vector between the intelligent omni-surface and the base station, gₖ∈C^{M×1} is a channel vector between the user k and the intelligent omni-surface, Θ₁=diag {e^{jθ}^{₁}¹e^{jθ}^{₂}¹ . . . e^{jθ}^{_{M}}¹} and Θ₂=diag{e^{jθ}^{₁}²e^{jθ}^{₂}² . . . e^{jθ}^{_{M}}²} are a reflected beamforming matrix and a transmitted beamforming matrix respectively, σ² is a variance of an additive white Gaussian noise, C^{M×1} represents a complex column vector of M dimension, |⋅|² represents a square of a complex modulus, (·)^{H} represents a conjugate transpose of a vector, diag {⋅} represents to converting the vector to a diagonal matrix, and e^{j⋅} represents an exponential form of complex number; and
the constraint condition 1 is the minimum rate constraint of the user; the constraint condition 2 is the phase shift constraint of the intelligent omni-surface; and the constraint condition 3 is the length constraint of the total slot time of the time slot 1 and the time slot 2 after normalization.

6. The communication system design method based on the intelligent omni-surface according to claim 5, wherein the method for solving the optimization problem after setting with the constraint condition in the step 3 comprises:
step 3-1: calculating the phase shift of the intelligent omni-surface; and
step 3-2: calculating the transmit power of the user and the time slot length.

7. The communication system design method based on the intelligent omni-surface according to claim 6, wherein the method for the calculating the phase shift of the intelligent omni-surface in the step 3-1 comprises:
the method for calculating the phase shift θₘ^{k} of the m^{th} element of the intelligent omni-surface in the time slot k is as follows:
$${θ}_{m}^{k} = \{ \begin{matrix}{θ}_{m}^{h} - {θ}_{m}^{{g}_{k}} , & if {θ}_{m}^{h} - {θ}_{m}^{{g}_{k}} \geq 0 \\ 2 π + ( {θ}_{m}^{h} - {θ}_{m}^{{g}_{k}} ) , & if {θ}_{m}^{h} - {θ}_{m}^{{g}_{k}} < 0\end{matrix}$$
wherein, θₘ^{h} and θₘ^{g}^{ₖ} are phases of m^{th} elements of vectors h and gₖ respectively, k∈{1,2} and m∈{1,2, . . . , M}.

8. The communication system design method based on the intelligent omni-surface according to claim 7, wherein the method for the calculating the transmit power of the user and the time slot length in the step 3-2 comprises:
step 3-2-1: initializing a searching step-size Δt and a search index τ=0;
step 3-2-2: updating an iteration index τ=τ+1 and the time slot length t₂=τ×Δt;
step 3-2-3: calculating the transmit power for the user;
step 3-2-4: calculating the total power consumption of the system during the τ^{th} iteration:
$${P}_{sum}^{τ} = {p}_{1} + {p}_{2} ;$$
step 3-2-5: when t₂<1, executing the step 3-2-2; otherwise, executing step 3-2-6;
step 3-2-6: according to all the obtained total power consumption of the system {Pₛᵤₘ^{τ}}, calculating the optimal iteration index τₒₚ corresponding to the minimum total power consumption of the system, which is
$${τ}_{op} = {min}_{τ} \{ {P}_{sum}^{τ} \} ;$$
and
step 3-2-7: outputting the optimal time slot length t₂^{op}=τₒₚ×Δt; and outputting the optimal transmit power.

9. The communication system design method based on the intelligent omni-surface according to claim 8, wherein the method for calculating the transmit power of the user in the step 3-2-3 is as follows:
$${p}_{1} = \frac{{σ}^{2}}{{\vert {h}^{H} {Θ}_{1} {g}_{1} \vert}^{2}} ( {2}^{\frac{{R}_{1}^{min}}{1 - {t}_{2}}} - 1 )$$
$${p}_{2} = \frac{{σ}^{2}}{{\vert {h}^{H} {Θ}_{2} {g}_{2} \vert}^{2}} ( {2}^{\frac{{R}_{2}^{min}}{{t}_{2}}} - 1 ) .$$

10. The communication system design method based on the intelligent omni-surface according to claim 9, wherein the optimal transmit power in the step 3-2-7 is:
$${p}_{1}^{op} = \frac{{σ}^{2}}{{\vert {h}^{H} {Θ}_{1} {g}_{1} \vert}^{2}} ( {2}^{\frac{{R}_{1}^{min}}{{t}_{1}^{op}}} - 1 )$$
$${p}_{2}^{op} = \frac{{σ}^{2}}{{\vert {h}^{H} {Θ}_{2} {g}_{2} \vert}^{2}} ( {2}^{\frac{{R}_{2}^{min}}{{t}_{2}^{op}}} - 1 )$$
wherein, p₁^{op} and p₂^{op} represent optimal transmit powers of a user 1 and a user 2 respectively, while t₁^{op} and t₂^{op} represent optimal lengths of the time slot 1 and the time slot 2 respectively.
